(19) United States
(12) Patent Application Publication
(10) Pub. No.: US 2024/0003454 A1
(43) Pub. Date: Jan. 4, 2024

(54) VALVE DEVICE

(71) Applicant: DENSO CORPORATION, Kariya-city (JP)

(72) Inventors: Yoshitada AONO, Kariya-city (JP); Atsushi TANAKA, Kariya-city (JP)

(21) Appl. No.: 18/469,073

(22) Filed: Sep. 18, 2023

Related U.S. Application Data
(63) Continuation of application No. PCT/JP2022/015521, filed on Mar. 29, 2022.

(30) Foreign Application Priority Data
Apr. 21, 2021 (JP) 2021-071791

(51) Int. Cl. F16K 27/04; F16K 11/074

(52) U.S. Cl. CPC F16K 27/045; F16K 11/0743

(57) ABSTRACT

A valve device includes a drive device, a valve element, a housing main body, a main-body cover and a seal member. The housing main body has a main-body connecting portion and a main body fastening portion. The main-body cover has a cover connecting portion and a cover fastening portion. At least one of the housing main body and the main-body cover has a corresponding one of: a rigidity reducing structure that reduces a rigidity of the main-body connecting portion; and a rigidity reducing structure that reduces a rigidity of the cover connecting portion. The rigidity reducing structure is a space that reduces the rigidity.

### CROSS REFERENCE TO RELATED APPLICATIONS

This application is a continuation application of International Patent Application No. PCT/JP2022/015521 filed on Mar. 29, 2022, which designated the U.S. and claims the benefit of priority from Japanese Patent Application No. 2021-071791 filed on Apr. 21, 2021. The entire disclosures of all of the above applications are incorporated herein by reference.

### TECHNICAL FIELD

The present disclosure relates to a valve device.

### BACKGROUND

Previously, there is proposed a valve device that has: a shaft, which extends in an axial direction of a predetermined central axis; and a valve element while the shaft and the valve element are received at a receiving space formed by a housing main body and a main-body cover. In this valve device, the housing main body and the main-body cover are fastened together by a plurality of screws. Furthermore, in this valve device, a seal member, which is placed between the housing main body and the main-body cover, is resiliently deformed in the axial direction of the predetermined central axis to seal a gap between the housing main body and the main-body cover and thereby close between the receiving space and the outside of the valve device.

Each of the housing main body and the main-body cover of the valve device discussed above has a plurality of contact surfaces at portions thereof which are fastened with the screws. For instance, in a case where a degree of flatness of one or more of these contact surfaces is lower than a designed degree of flatness (designed accuracy) or a case where surface heights of these contact surfaces vary from each other, the housing main body and the main-body cover may be fastened together while at least one of the housing main body and the main-body cover is tilted relative to the axial direction of the predetermined central axis.

### SUMMARY

This section provides a general summary of the disclosure, and is not a comprehensive disclosure of its full scope or all of its features.

According to one aspect of the present disclosure, there is provided a valve device that includes a drive device, a valve element, a housing main body, a main body cover and a seal member. The drive device is configured to output a rotational force. The valve element has a flow passage and is configured to adjust a flow rate of a fluid flowing in the flow passage when the valve element is rotated about a predetermined central axis by the rotational force outputted from the drive device. The housing main body has a main-body peripheral wall and an opening. The main-body peripheral wall surrounds the predetermined central axis and forms a receiving space which receives the valve element. The opening is formed at the housing main body on one side in an axial direction of the predetermined central axis. The main-body cover has a cover peripheral wall and is fastened to the housing main body and thereby closes the receiving space. The seal member is resiliently deformed between the housing main body and the main-body cover. The housing main body has a main-body connecting portion and a main-body fastening portion. The main-body connecting portion radially outwardly extends from the main-body peripheral wall to a location which is on a radially outer side of the seal member in a radial direction of the predetermined central axis. The main-body fastening portion is joined to a radially outer end part of the main-body connecting portion and has a fastening surface which contacts the main-body cover. The main-body cover has a cover connecting portion and a cover fastening portion. The cover connecting portion radially outwardly extends from the cover peripheral wall to a location which is on the radially outer side of the seal member in the radial direction of the predetermined central axis. The cover fastening portion is joined to a radially outer end part of the cover connecting portion and has a contact surface which contacts the fastening surface. At least one of the housing main body and the main-body cover has a corresponding one of: a rigidity reducing structure that includes a main-body rigidity reducing part that reduces a rigidity of the main-body connecting portion in comparison to a case where the main-body rigidity reducing part is absent at the main-body connecting portion; and a rigidity reducing structure that includes a cover rigidity reducing part that reduces a rigidity of the cover connecting portion in comparison to a case where the cover rigidity reducing part is absent at the cover connecting portion. At least one of the rigidity reducing structures is a structure that has a space which reduces the rigidity of a corresponding one of the main-body connecting portion and the cover connecting portion.

According to another aspect of the present disclosure, there is provided a valve device that includes a drive device, a valve element, a housing main body, a main-body cover and a seal member. The drive device is configured to output a rotational force. The valve element has a flow passage and is configured to adjust a flow rate of a fluid flowing in the flow passage when the valve element is rotated about a predetermined central axis by the rotational force outputted from the drive device. The housing main body receives the valve element at an inside of the housing main body and has an opening which is formed at the housing main body on one side in an axial direction of the predetermined central axis. The main-body cover is fastened to the housing main body and thereby closes the opening. The seal member is resiliently deformed between the housing main body and the main-body cover to seal a gap between the housing main body and the main-body cover. The housing main body has a main-body fastening portion. The main-body fastening portion is located on a radially outer side of the seal member in a radial direction of the predetermined central axis and has a fastening surface which contacts the main-body cover when the housing main body and the main-body cover are fastened together. The main-body cover has a cover fastening portion. The cover fastening portion is located on the radially outer side of the seal member in the radial direction of the predetermined central axis and has a contact surface which contacts the fastening surface. One of the housing main body and the main-body cover is formed by a member that has a lower rigidity in comparison to another one of the housing main body and the main-body cover.

### BRIEF DESCRIPTION OF DRAWINGS

The drawings described herein are for illustrative purposes only of selected embodiments and not all possible implementations, and are not intended to limit the scope of the present disclosure.

FIG. 1 is a front view of a valve device of an embodiment.

FIG. 2 is a side view of the valve device seen in a direction of an arrow II in FIG. 1.

FIG. 3 is a cross-sectional view taken along line III-III in FIG. 2.

FIG. 4 is an enlarged view of a portion IV in FIG. 3.

FIG. 5 is a cross-sectional view of the valve device of the embodiment.

FIG. 6 is a top view of a main body seen in a direction of an arrow VI in FIG. 5.

FIG. 7 is a top view of a main-body cover of the valve device of the embodiment.

FIG. 8 is a bottom view of the main-body cover of the valve device of the embodiment.

FIG. 9 is a diagram showing a state where a crack is generated at an inside of a valve device of a comparative example.

FIG. 10 is a diagram showing a state where a crack is generated at an inside of the valve device of the embodiment.

FIG. 11 is a cross-sectional view of a valve device of another embodiment.

### DETAILED DESCRIPTION

Previously, there is proposed a valve device that has: a shaft, which extends in an axial direction of a predetermined central axis; and a valve element while the shaft and the valve element are received at a receiving space formed by a housing main body and a main-body cover. In this valve device, the housing main body and the main-body cover are fastened together by a plurality of screws. Furthermore, in this valve device, a seal member, which is placed between the housing main body and the main-body cover, is resiliently deformed in the axial direction of the predetermined central axis to seal a gap between the housing main body and the main-body cover and thereby close between the receiving space and the outside of the valve device.

Each of the housing main body and the main-body cover of the valve device discussed above has a plurality of contact surfaces at portions thereof which are fastened with the screws. For instance, in a case where a degree of flatness of one or more of these contact surfaces is lower than a designed degree of flatness (designed accuracy) or a case where surface heights of these contact surfaces vary from each other, the housing main body and the main-body cover may be fastened together while at least one of the housing main body and the main-body cover is tilted relative to the axial direction of the predetermined central axis. When the housing main body and the main-body cover are fastened together by the screws in the tilted state where at least one of the housing main body and the main-body cover is tilted relative to the axial direction of the predetermined central axis, an excessive load is applied to the contact surfaces of the housing main body and the main-body cover to cause deformation of at least one of the housing main body and the main-body cover.

As a result of extensive study conducted by the inventors of the present application, it is found that when at least one of the housing main body and the main body cover is deformed, a force for compressing the seal member is changed to cause a change in the amount of elastic deformation of the seal member as compared to a case where the housing main body and the main body cover are not deformed. Furthermore, it is also found that when the amount of deformation of the seal member is reduced in comparison to the case where the housing main body and the main-body cover are not deformed, the gap between the housing main body and the main-body cover may not be sealed by the seal member. This may result in that a required degree of sealing of the receiving space cannot be ensured, and thereby the fluid is leaked from the receiving space to the outside of the valve device.

According to one aspect of the present disclosure, there is provided a valve device including:
a drive device that is configured to output a rotational force;
a valve element that has a flow passage which is configured to conduct a fluid through the flow passage, wherein the valve element is configured to adjust a flow rate of the fluid flowing in the flow passage when the valve element is rotated about a predetermined central axis by the rotational force outputted from the drive device;
a housing main body that has:
   a main-body peripheral wall which surrounds the predetermined central axis and forms a receiving space, wherein the receiving space receives the valve element; and
   an opening which is formed at the housing main body on one side in an axial direction of the predetermined central axis;
a main-body cover that has a cover peripheral wall which surrounds the predetermined central axis, wherein the main-body cover is fastened to the housing main body and thereby closes the receiving space; and
a seal member that is resiliently deformed between the housing main body and the main-body cover to seal a gap between the housing main body and the main-body cover, wherein:
the housing main body has:
   a main-body connecting portion that radially outwardly extends from the main-body peripheral wall to a location which is on a radially outer side of the seal member in a radial direction of the predetermined central axis; and
   a main-body fastening portion that is joined to a radially outer end part of the main-body connecting portion and has a fastening surface which contacts the main-body cover;
the main-body cover has:
   a cover connecting portion that radially outwardly extends from the cover peripheral wall to a location which is on the radially outer side of the seal member in the radial direction of the predetermined central axis; and
   a cover fastening portion that is joined to a radially outer end part of the cover connecting portion and has a contact surface which contacts the fastening surface;
at least one of the housing main body and the main-body cover has a corresponding one of:
   a rigidity reducing structure that includes a main-body rigidity reducing part that reduces a rigidity of the main-body connecting portion in comparison to a case where the main-body rigidity reducing part is absent at the main-body connecting portion; and
   a rigidity reducing structure that includes a cover rigidity reducing part that reduces a rigidity of the cover connecting portion in comparison to a case where the cover rigidity reducing part is absent at the cover connecting portion; and
at least one of the rigidity reducing structures is a structure that has a space which reduces the rigidity of a corresponding one of the main-body connecting portion and the cover connecting portion.

According to the above configuration, in the case where the space is formed at the main-body connecting portion, even when an excessive load is applied to the contact surface at the time of fastening the housing main body and the main-body cover due to a relatively low degree of flatness of at least one of the fastening surface and the contact surface, the main-body connecting portion is more likely to be deformed in comparison to a portion which is located on a radially inner side of the main-body connecting portion. Furthermore, in the case where the space is formed at the cover connecting portion, even when an excessive load is applied to the contact surface at the time of fastening the housing main body and the main-body cover due to a relatively low degree of flatness of at least one of the fastening surface and the contact surface, the cover connecting portion is more likely to be deformed in comparison to a portion which is located on a radially inner side of the cover connecting portion.

Therefore, it is possible to limit deformation of the portion of the housing main body and the portion of the main-body cover, which are located on the radially inner side of the main-body connecting portion and the cover connecting portion and compress the seal member. Therefore, it is possible to limit a decrease in the amount of resilient deformation of the seal member caused by the deformation of at least one of the housing main body and the main-body cover, and thereby it is possible to ensure the required degree of sealing of the receiving space.

According to another aspect of the present disclosure, there is provided a valve device including:
a drive device that is configured to output a rotational force;
a valve element that has a flow passage which is configured to conduct a fluid through the flow passage, wherein the valve element is configured to adjust a flow rate of the fluid flowing in the flow passage when the valve element is rotated about a predetermined central axis by the rotational force outputted from the drive device;
a housing main body that receives the valve element at an inside of the housing main body and has an opening which is formed at the housing main body on one side in an axial direction of the predetermined central axis;
a main-body cover that is fastened to the housing main body and thereby closes the opening;
a seal member that is resiliently deformed between the housing main body and the main-body cover to seal a gap between the housing main body and the main-body cover, wherein:
the housing main body has a main-body fastening portion, wherein the main-body fastening portion is located on a radially outer side of the seal member in a radial direction of the predetermined central axis and has a fastening surface which contacts the main-body cover when the housing main body and the main-body cover are fastened together;
the main-body cover has a cover fastening portion, wherein the cover fastening portion is located on the radially outer side of the seal member in the radial direction of the predetermined central axis and has a contact surface which contacts the fastening surface; and
one of the housing main body and the main-body cover is formed by a member that has a lower rigidity in comparison to another one of the housing main body and the main-body cover.

According to the above configuration, even when an excessive load is applied to the contact surface at the time of fastening the housing main body and the main-body cover due to a relatively low degree of flatness of at least one of the fastening surface and the contact surface, the another one of the housing main body and the main-body cover, which has the higher rigidity, is less likely to be deformed in comparison to the one of the housing main body and the main-body cover, which has the lower rigidity. Therefore, in comparison to the case where the housing main body and the main-body cover are respectively formed by members which have the same rigidity, it is possible to limit deformation of the other one of the housing main body and the main-body cover, which has the higher rigidity, in response to deformation of the one of the housing main body and the main-body cover, which has the lower rigidity. Thus, the required degree of sealing of the receiving space can be more easily ensured.

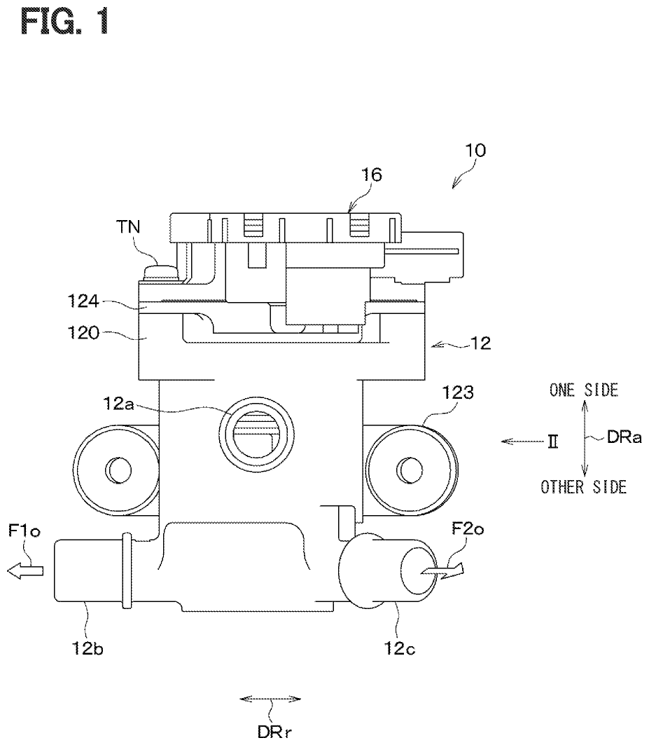

Hereinafter, an embodiment of the present disclosure will be described with reference to FIGS. 1 to 10. In the present embodiment, there will be described an example where a valve device 10 of the present disclosure is applied to a temperature adjusting device that is for air conditioning of a vehicle cabin and is also for temperature control of a battery at an electric vehicle. The valve device 10, which is used in the temperature adjusting device of the electric vehicle, is required to execute fine adjustment of the temperature according to a state of the vehicle cabin and a state of the battery and is required to accurately adjust a flow rate of a fluid in comparison to a coolant circuit of an internal combustion engine.

The valve device 10 shown in FIG. 1 is applied to a fluid circuit in which the fluid (in this example, coolant) for adjusting the temperature of the vehicle cabin and the temperature of the battery is circulated to adjust the temperature of the vehicle cabin and the temperature of the battery. The valve device 10 can increase or decrease the flow rate of the fluid in a flow path through the valve device 10 in the fluid circuit, and the valve device 10 can also shut off the flow of the fluid in the flow path. For example, an LLC, which contains ethylene glycol, is used as the fluid. Here, LLC stands for Long Life Coolant.

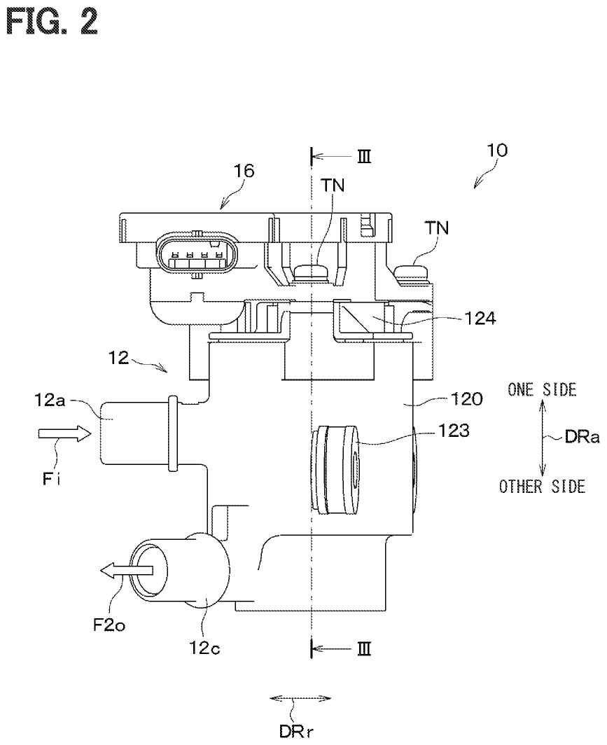

As sown in FIGS. 1 and 2, the valve device 10 includes a housing 12 that forms a fluid passage that is formed at an inside of the housing 12 and conducts the fluid through the fluid passage. The valve device 10 is a three-way valve and has an inlet 12a for inputting the fluid, a first outlet 12b for outputting the fluid, and a second outlet 12c for outputting the fluid while the inlet 12a, the first outlet 12b and the second outlet 12c are formed at the housing 12. The valve device 10 functions not only as a flow-path switching valve but also as a flow-rate adjusting valve for adjusting a flow rate ratio between the fluid flowing from the inlet 12a to the first outlet 12b and the fluid flowing from the inlet 12a to the second outlet 12c.

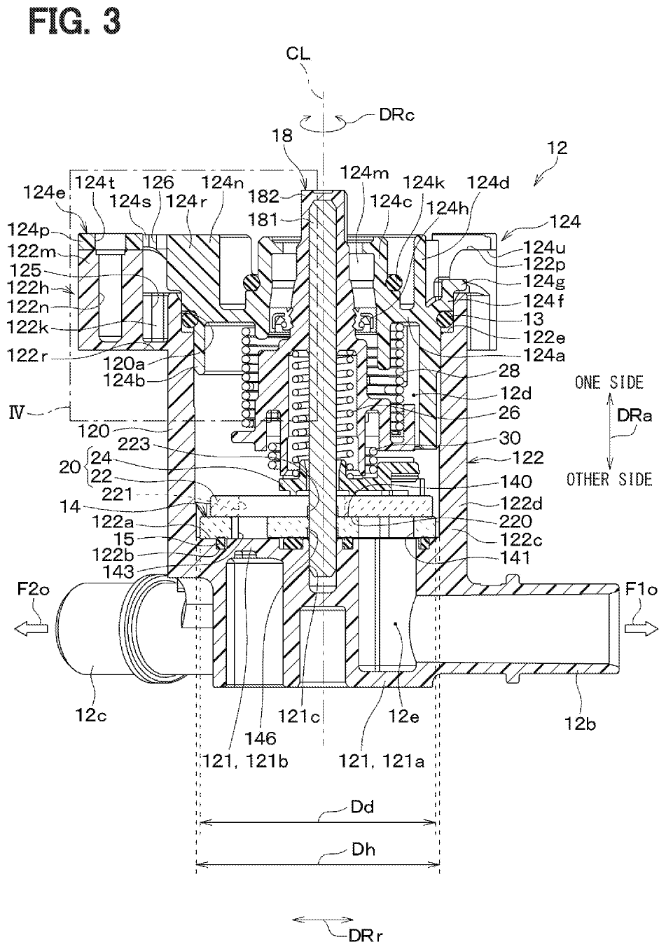

As shown in FIG. 3, the valve device 10 is a disc valve that performs a valve opening/closing operation by rotating a rotor, which is shaped in a form of a circular disk, around a central axis CL of a shaft 18 described later. In the present embodiment, the various structures will be described upon assuming that a direction, which is along the central axis CL of the shaft 18 described later, will be referred to as an axial direction DRa, and a direction, which is perpendicular to the axial direction DRa and radiates from the axial direction DRa, will be referred to as a radial direction DRr. Furthermore, in the present embodiment, the various structures will be described upon assuming that a direction, which is around the central axis CL, will be referred to as a circumferential direction DRc. In FIG. 3, a drive device 16 is omitted to make the drawing easy to see.

The valve device 10 includes a stationary disk 14, the shaft 18, a valve element 20, a compression spring 26, a first torsion spring 28 and a second torsion spring 30 which are received at the inside of the housing 12. Furthermore, the valve device 10 includes the drive device 16 which is placed at an outside of the housing 12.

The housing 12 is a non-rotatable member that is not rotated. The housing 12 is made of, for example, a resin material. The housing 12 includes a main body 120 and a main-body cover 124. The main body 120 is shaped in a bottomed tubular form and extends in the axial direction DRa. The main-body cover 124 closes an opening 120a of the main body 120 which is located on one side in the axial direction DRa. Each of the main body 120 and the main-body cover 124 is molded by injection molding, in which a resin material is filled into a mold and is solidified into a desired shape. The main body 120 serves as a housing main body.

The main body 120 has: a bottom wall 121 which forms a bottom surface; and a main-body peripheral wall 122 which surrounds the central axis CL. The main-body peripheral wall 122 cooperates with the main-body cover 124 to form a receiving space that receives the valve element 20. The bottom wall 121 and the main-body peripheral wall 122 are formed integrally in one-piece as an integral molded portion.

The bottom wall 121 has two recesses respectively formed by a step at two portions of the bottom wall 121, which respectively correspond to a first passage hole 141 and a second passage hole 142 of the stationary disk 14 described later. In contrast, the recess is not formed at another portion of the bottom wall 121, which is opposed to a third passage hole 143 of the stationary disk 14. Specifically, a distance between the main-body cover 124 and each of the two portions of the bottom wall 121, which are respectively opposed to the first passage hole 141 and the second passage hole 142 of the stationary disk 14, is larger than a distance between the main-body cover 124 and the other portion of the bottom wall 121, which is opposed to the third passage hole 143 of the stationary disk 14.

The bottom wall 121 has: two stepped portions 121a each of which has the recess formed by the step and is opposed to the corresponding one of the first passage hole 141 and the second passage hole 142 of the stationary disk 14; and a non-stepped portion 121b, which does not have the recess and is opposed to the third passage hole 143 of the stationary disk 14. In the bottom wall 121, each of the stepped portions 121a is largely spaced from the stationary disk 14, and the non-stepped portion 121b is close to the stationary disk 14.

At the main-body peripheral wall 122, the inlet 12a is formed at a location that is closer to the opening 120a than to the bottom wall 121, and the first outlet 12b and the second outlet 12c are formed at a location that is closer to the bottom wall 121 than to the opening 120a. The inlet 12a, the first outlet 12b and the second outlet 12c are respectively formed as a tubular member that has a flow passage at an inside thereof.

A mounting portion 122a, on which the stationary disk 14 is mounted, is formed at the inside of the main-body peripheral wall 122 at a location that is between the portion of the main-body peripheral wall 122, at which the inlet 12a is formed, and the other portion of the main-body peripheral wall 122, at which the outlets 12b, 12c are formed. The main-body peripheral wall 122 has: a first disk opposing portion 122c which is opposed to the stationary disk 14 in the radial direction DRr; and a second disk opposing portion 122d which is opposed to a drive disk 22 in the radial direction DRr.

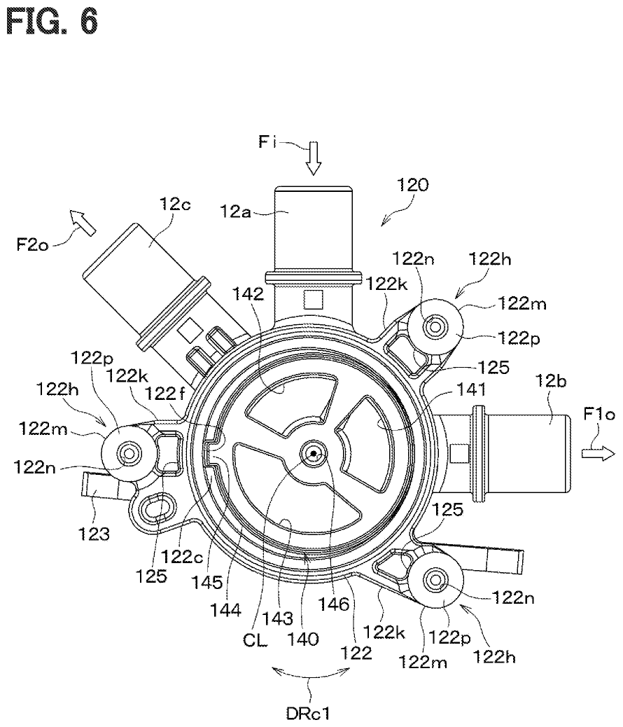

Furthermore, at the inside of the main-body peripheral wall 122, a seal installation portion 122e, at which a seal member 13 described later is installed, is formed at a location which is closer to the opening 120a than to the first disk opposing portion 122c and the second disk opposing portion 122d. Furthermore, as shown in FIG. 6, a receiving groove 122f, which receives a rotation stop projection 145 of the stationary disk 14 described later, is formed at an inside of the first disk opposing portion 122c in the main-body peripheral wall 122.

A plurality of main-body attachment portions 122h, at which the main-body cover 124 is attached to the main body 120, and a plurality of installation portions 123, through which the valve device 10 is installed to the electric vehicle, are formed at the outside of the main-body peripheral wall 122. Each of the installation portions 123 is a portion that is coupled to the electric vehicle at the time of installing the valve device 10 to the electric vehicle, and the installation portion 123 has a through-hole through which a coupling member for coupling with the electric vehicle is inserted.

The mounting portion 122a is a portion that contacts a back surface of the stationary disk 14 which is opposite to an opening surface 140 of the stationary disk 14. The mounting portion 122a is formed at a location at which an inner diameter changes at the main-body peripheral wall 122. Specifically, the mounting portion 122a is a planar portion that extends in the radial direction DRr. The mounting portion 122a has a receiving groove 122b that receives a gasket 15 described later.

The first disk opposing portion 122c is formed such that an inner diameter Dh of the first disk opposing portion 122c without the receiving groove 122f is larger than an outer diameter Dd of the stationary disk 14 without the rotation stop projection 145. With this configuration, in a state where the stationary disk 14 is installed to the mounting portion 122a, a gap is formed between the stationary disk 14 and the main-body peripheral wall 122. In other words, the stationary disk 14 is not positioned by the main-body peripheral wall 122.

The receiving groove 122f is formed by radially recessing the inside of the first disk opposing portion 122c away from the central axis CL. A portion of the first disk opposing portion 122c, at which the receiving groove 122f is formed, has a sufficient thickness in comparison to a radial depth of the receiving groove 122f. Furthermore, the receiving groove 122f is formed at a location that is circumferentially displaced from a location interposed between the central axis CL and the first outlet 12b in the radial direction DRr and is also circumferentially displaced from a location interposed between the central axis CL and the second outlet 12c in the radial direction DRr.

An inner diameter of the second disk opposing portion 122d is larger than an inner diameter of the first disk opposing portion 122c. Furthermore, the inner diameter of the second disk opposing portion 122d is larger than an outer diameter of the drive disk 22. With this configuration, a gap is formed between the drive disk 22 and the main-body peripheral wall 122. Specifically, the drive disk 22 does not contact the main-body peripheral wall 122 and is not positioned by the main-body peripheral wall 122. The outer diameter of the drive disk 22 is substantially the same as the outer diameter Dd of the stationary disk 14.

The inside of the housing 12 is partitioned into an inlet-side space 12d and an outlet-side space 12e by the stationary disk 14 while the inlet-side space 12d and the outlet-side space 12e are communicated with the first passage hole 141. The inlet-side space 12d is a space communicated with the inlet 12a at the inside of the housing 12 and is also the receiving space which receives the valve element 20. The outlet-side space 12e is a space communicated with the first outlet 12b and the second outlet 12c at the inside of the housing 12.

Although not depicted in the drawing, the inside of the main body 120 is provided with a partition, which is shaped in a plate form and partitions between a first outlet-side space, which communicates the outlet-side space 12e to the first passage hole 141, and a second outlet-side space, which communicates the outlet-side space 12e to the second passage hole 142. This partition extends across the outlet-side space 12e in the radial direction DRr.

The seal installation portion 122e is formed by a planar portion which extends in the radial direction DRr and is formed by increasing an inner diameter of the end portion of the main-body peripheral wall 122, which is adjacent to the opening 120a, in comparison to the other portion of the main-body peripheral wall 122. The seal installation portion 122e is a portion at which the seal member 13 for sealing a gap between the main body 120 and the main-body cover 124 is installed.

Each of the main-body attachment portions 122h projects radially outward in the radial direction DRr from the end portion of the main-body peripheral wall 122 at which the opening 120a is formed. As shown in FIG. 6, the number of the main-body attachment portions 122h is three, and these three main-body attachment portions 122h are arranged at predetermined intervals in the circumferential direction DRc.

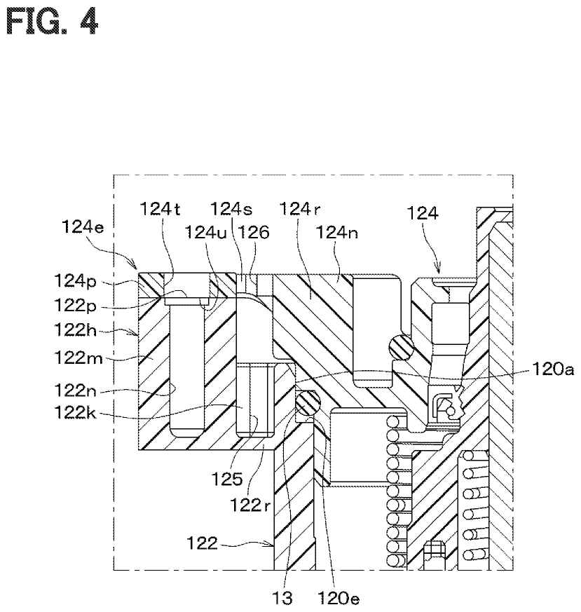

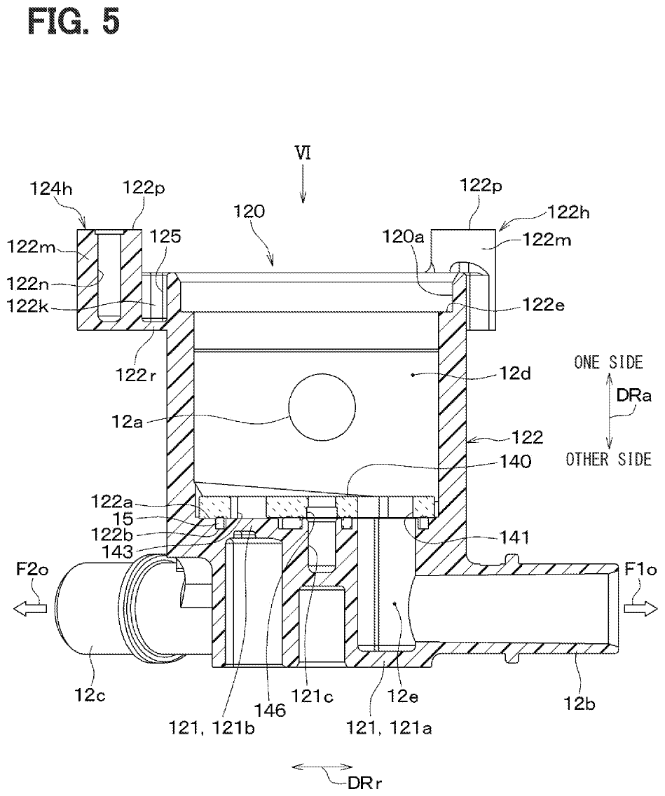

Each of the three main-body attachment portions 122h has a main-body connecting portion 122k and a main-body fastening portion 122m. The main-body connecting portion 122k extends outward from the main-body peripheral wall 122 in the radial direction DRr. The main-body fastening portion 122m is joined to an end part of the main-body connecting portion 122k which is radially opposite to a part of the main-body connecting portion 122k that is joined to the main-body peripheral wall 122. The main-body connecting portion 122k and the main-body fastening portion 122m are formed integrally in one-piece as an integral molded portion. As shown in FIGS. 4 to 6, each of the three main-body attachment portions 122h has an identical basic structure. Therefore, only one of these three main-body attachment portions 122h will be described while description of the other two of the main-body attachment portions 122h is omitted. In FIG. 5, various components received at the inside of the main body 120 are not depicted for the sake of simplicity.

The main-body connecting portion 122k joins between an outer periphery of the main-body peripheral wall 122 and the main-body fastening portion 122m and ensures a required distance between the outer periphery of the main-body peripheral wall 122 and the main-body fastening portion 122m. The main-body connecting portion 122k is shaped in a plate form, a thickness direction of which coincides with the axial direction DRa, and the main-body connecting portion 122k radially outwardly extends from the main-body peripheral wall 122 to a location which is on a radially outer side of the seal member 13 in the radial direction DRr. Furthermore, a radially inner end part of the main-body connecting portion 122k is joined to the outer periphery of the main-body peripheral wall 122, and a radially outer end part of the main-body connecting portion 122k is joined to the main-body fastening portion 122m.

An axial size of the main-body connecting portion 122k measured in the axial direction DRa is larger than a radial size of the main-body connecting portion 122k measured in the radial direction DRr. Furthermore, a size of the main-body connecting portion 122k, which is measured in a perpendicular direction being perpendicular to the radial direction DRr and the axial direction DRa, is larger than the radial size of the main-body connecting portion 122k measured in the radial direction DRr.

The main-body connecting portion 122k has a rigidity reducing structure that includes a main-body rigidity reducing part 125 which reduces a rigidity of the main-body connecting portion 122k. The main-body rigidity reducing part 125 reduces the rigidity of the main-body connecting portion 122k in comparison to the main-body peripheral wall 122 and the main-body fastening portion 122m. The main-body rigidity reducing part 125 will be described later in detail.

The main-body fastening portion 122m is a portion to which a fastening member TN for fastening the main body 120 and the main-body cover 124 together is installed. The main-body fastening portion 122m is shaped in a tubular form and extends in the axial direction DRa, and the main-body fastening portion 122m is located on the radially outer side of the main-body connecting portion 122k in the radial direction DRr. An axial size of the main-body fastening portion 122m, which is measured in the axial direction DRa, is larger than the axial size of the main-body connecting portion 122k, which is measured in the axial direction DRa, and the main-body fastening portion 122m projects from the main-body connecting portion 122k toward the one side in the axial direction DRa.

Specifically, the one-side end of the main-body fastening portion 122m, which is located on the one side in the axial direction DRa, is placed at a location that is closer to the drive device 16 in comparison to one-side end of the main-body connecting portion 122k, which is located on the one side in the axial direction DRa. In contrast, a location of the other-side end of the main-body fastening portion 122m, which is located on the other side in the axial direction DRa, is the same as a location of the other-side end of the main-body connecting portion 122k, which is located on the other side in the axial direction DRa.

A main body insertion hole 122n, into which a fastening member TN for fastening the main-body cover 124 to the main body 120, is formed at the main-body fastening portion 122m and extends in the axial direction DRa. When the fastening member TN is inserted into the main body insertion hole 122n and a cover insertion hole 124t described later, the main body 120 and the main-body cover 124 are fastened together. An inner diameter of the main body insertion hole 122n is slightly smaller than an outer diameter of a portion of the fastening member TN, which is inserted into the main body insertion hole 122n.

In the present embodiment, a tapping screw, which is made of a metal material, is used as the fastening member TN for fastening the main body 120 and the main-body cover 124 together. Therefore, the fastening member TN is threadably inserted into the main-body fastening portion 122m and is tightened at the time of fastening the main-body cover 124 to the main body 120. The main-body fastening portion 122m has a fastening surface 122p which contacts the main-body cover 124 at the time of fastening the main body 120 and the main-body cover 124 together.

The fastening surface 122p is a planar surface part of the main-body fastening portion 122m located on the one side in the axial direction DRa. A location of the fastening surface 122p is displaced from an installation location of each of the seal member 13 and the main-body fastening portion 122m toward the one side in the axial direction DRa. In the valve device 10 of the present embodiment, the number of the fastening surfaces 122p which contact the main-body cover 124 at the time of fastening the main-body cover 124 to the main body 120, is three.

The main-body cover 124 is a lid member that covers the opening 120a of the main body 120. As shown in FIGS. 3, 7 and 8, the main-body cover 124 has a plate portion 124a, a rib portion 124b, a housing boss portion 124c, a cover peripheral wall 124d and a plurality of cover attachment portions 124e. The plate portion 124a, the rib portion 124b, the housing boss portion 124c, the cover peripheral wall 124d and the cover attachment portions 124e are formed integrally in one-piece as an integral molded portion.

The plate portion 124a is shaped in a circular ring form that extends in the radial direction DRr. In the main-body cover 124, the plate portion 124a forms the inlet-side space 12d in corporation with the main-body peripheral wall 122 and the stationary disk 14.

Furthermore, an outer diameter of the plate portion 124a is increased stepwise from the other side toward the one side in the axial direction DRa. Specifically, the plate portion 124a has: a seal support portion 124f, which is located on the other side in the axial direction DRa; and a lid portion 124g, which is connected to the seal support portion 124f. In the plate portion 124a, an outer diameter of the lid portion 124g is larger than an outer of the seal support portion 124f.

The seal support portion 124f is a portion for clamping the seal member 13 installed at the seal installation portion 122e. The outer diameter of the seal support portion 124f is slightly smaller than an inner diameter of the opening 120a. Therefore, a gap is formed between an inner periphery of the opening 120a and an outer periphery of the seal support portion 124f.

The seal support portion 124f clamps the seal member 13 between a surface of the seal support portion 124f, which is located on the other side in the axial direction DRa, and the seal installation portion 122e when the seal support portion 124f is inserted from the opening 120a into the inlet-side space 12d. Therefore, the gap between the inner periphery of the opening 120a and the outer periphery of the seal support portion 124f is sealed by the seal member 13.

The lid portion 124g is a portion that closes the opening 120a at the time of fastening the main body 120 and the main-body cover 124 together. The lid portion 124g is located on the outer side of the seal support portion 124f in the radial direction DRr. The outer diameter of the lid portion 124g is larger than an inner diameter of the opening 120a of the main body 120, so that the lid portion 124g cannot be inserted into the opening 120a. Furthermore, the outer diameter of the lid portion 124g is substantially the same as an outer diameter of the main-body peripheral wall 122.

The seal member 13 is made of urethane rubber, which is an elastomer, and the seal member 13 is resiliently deformable in the axial direction DRa when the seal member 13 is clamped between the seal support portion 124f and the seal installation portion 122e. The seal member 13 is a member shaped in a ring form, a thickness direction of which coincides with the axial direction DRa. In the present embodiment, an O-ring is used as the seal member 13.

An outer diameter of the seal member 13 is slightly smaller than an inner diameter of the opening 120a, and an inner diameter of the seal member 13 is slightly larger than an outer diameter of the rib portion 124b. In other words, the seal member 13 has: the outer diameter which is slightly smaller than the inner diameter of the opening 120a of the main body 120; and the inner diameter which is slightly larger than the outer diameter of the rib portion 124b.

When the main body 120 and the main-body cover 124 are fastened together, the seal member 13 is clamped and is compressed in the axial direction DRa between the surface of the seal support portion 124f located on the other side in the axial direction DRa and the seal installation portion 122e and is resiliently deformed to a predetermined desirable shape.

The rib portion 124b is a portion of the main-body cover 124 which is inserted into the opening 120a of the main body 120. The rib portion 124b is shaped in a tubular form and is located on the radially outer side of the plate portion 124a. The rib portion 124b projects from the plate portion 124a toward the bottom wall 121.

The housing boss portion 124c is a portion through which the shaft 18 is inserted at the inside thereof. The housing boss portion 124c is shaped in a tubular form and is located on the radially inner side of the plate portion 124a. A shaft seal 124h, which is shaped in a circular ring form and seals a gap between the housing boss portion 124c and the shaft 18, is installed at the inside of the housing boss portion 124c, and an O-ring 124k, which seals a gap between the housing boss portion 124c and the drive device 16, is installed at the outside of the housing boss portion 124c. Furthermore, a bearing 124m, which rotatably supports the shaft 18, is installed at the inside of the housing boss portion 124c. In the present embodiment, the housing boss portion 124c serves as a shaft support portion.

The drive device 16 is inserted at an inside of the cover peripheral wall 124d, and the cover peripheral wall 124d surrounds the central axis CL. The cover peripheral wall 124d is shaped in a tubular form and is located on the radially outer side of the housing boss portion 124c. The drive device 16 is inserted between an outer periphery of the housing boss portion 124c and an inner periphery of the cover peripheral wall 124d.

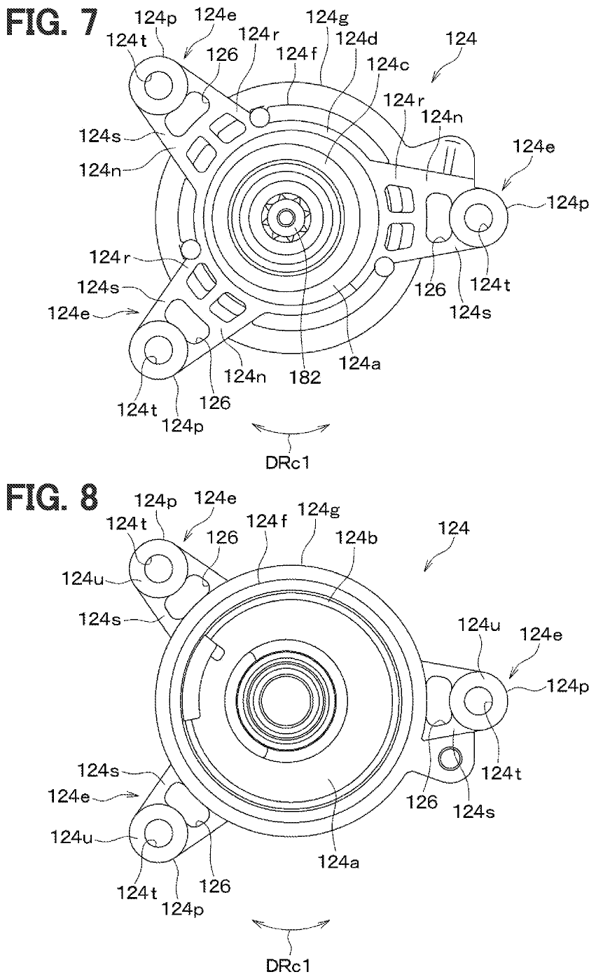

Each of the cover attachment portions 124e projects outward from an outer periphery of the cover peripheral wall 124d in the radial direction DRr. As shown in FIG. 7, the number of the cover attachment portions 124e is three, and these three cover attachment portions 124e are located on the radially outer side of the cover peripheral wall 124d and are arranged at predetermined intervals in the circumferential direction DRc. Each of the cover attachment portions 124e is placed at a location that corresponds to a corresponding one of the main-body attachment portions 122h. Specifically, each of the cover attachment portions 124e is placed at the location at which the cover attachment portion 124e overlaps with the corresponding one of the main-body attachment portions 122h in the axial direction DRa.

Each of the cover attachment portions 124e has a cover connecting portion 124n and a cover fastening portion 124p. The cover connecting portion 124n extends outward from the cover peripheral wall 124d in the radial direction DRr. The cover fastening portion 124p is joined to an end part of the cover connecting portion 124n which is radially opposite to a part of the cover connecting portion 124n that is joined to the cover peripheral wall 124d. The cover connecting portion 124n and the cover fastening portion 124p are formed integrally in one-piece as an integral molded portion. Each of the three cover attachment portions 124e has an identical basic structure. Therefore, only one of these three cover attachment portions 124e will be described while description of the other two of the cover attachment portions 124e is omitted.

The cover connecting portion 124n is a portion that joins between the outer periphery of the cover peripheral wall 124d and the cover fastening portion 124p. The cover connecting portion 124n is shaped in a plate form, a thickness direction of which coincides with the axial direction DRa, and the cover connecting portion 124n extends outward from the cover peripheral wall 124d in the radial direction DRr to a location which is on the radially outer side of the seal member 13 in the radial direction DRr. Furthermore, the outer periphery of the cover peripheral wall 124d is joined to a radially inner end part of the cover connecting portion 124n, and the cover fastening portion 124p is joined to the radially outer end part of the cover connecting portion 124n.

A size of the cover connecting portion 124n, which is measured in the axial direction DRa, is reduced from the radially inner side toward the radially outer side in the radial direction DRr. Specifically, the cover connecting portion 124n has an inner connecting portion 124r, which is located on the inner side in the radial direction DRr, and an outer connecting portion 124s which is joined to the inner connecting portion 124r. In the cover connecting portion 124n, the size of the outer connecting portion 124s, which is measured in the axial direction DRa, is smaller than the size of the inner connecting portion 124r, which is measured in the axial direction DRa.

The inner connecting portion 124r is a portion of the cover connecting portion 124n which is located on the inner side of the outer periphery of the main-body peripheral wall 122 in the radial direction DRr. In contrast, the outer connecting portion 124s is a portion of the cover connecting portion 124n, which is located on the outer side of the outer periphery of the main-body peripheral wall 122 in the radial direction DRr. Specifically, the outer connecting portion 124s projects to a location which is on the radially outer side of the main-body peripheral wall 122 in the radial direction DRr. The outer connecting portion 124s is located on the radially outer side of the seal member 13 in the radial direction DRr.

The outer connecting portion 124s is opposed to the main-body connecting portion 122k in the axial direction DRa. The outer connecting portion 124s has a rigidity reducing structure that includes a cover rigidity reducing part 126 which reduces a rigidity of the cover connecting portion 124n. The cover rigidity reducing part 126 will be described later in detail.

The cover fastening portion 124p is a portion to which the fastening member TN for fastening the main body 120 and the main-body cover 124 together is installed. The cover fastening portion 124p is shaped in a circular disk form, a thickness direction of the which coincides with the axial direction DRa, and the cover fastening portion 124p is located on the radially outer side of the cover connecting portion 124n in the radial direction DRr. The size of the cover fastening portion 124p measured in the axial direction DRa is smaller than the size of the inner connecting portion 124r measured in the axial direction DRa and is substantially the same as the size of the outer connecting portion 124s measured in the axial direction DRa.

The cover fastening portion 124p has: the cover insertion hole 124t, into which the fastening member TN for fastening the main-body cover 124 to the main body 120 is inserted; and a contact surface 124u, which contacts the fastening surface 122p at the time of fastening the main-body cover 124 to the main body 120. In the valve device 10 of the present embodiment, the number of contact surfaces 124u is three, and these three contact surfaces 124u are respectively placed at three locations which correspond to the three fastening surfaces 122p, respectively. The location of the contact surface 124u is displaced from the installation location of the seal member 13 toward the one side in the axial direction DRa.

The cover insertion hole 124t extends through the cover fastening portion 124p in the axial direction DRa from the one side to the other side of the cover fastening portion 124p in the axial direction DRa. The cover insertion hole 124t is placed at a location that corresponds to a location of the main body insertion hole 122n. In the present embodiment, the inner diameter of the cover insertion hole 124t is larger than the inner diameter of the main body insertion hole 122n and the outer diameter of the portion of the fastening member TN which is inserted into the main body insertion hole 122n. Therefore, at the time of fastening the main-body cover 124 to the main body 120, the fastening member TN is not threaded into the main-body cover 124 and is just inserted through the cover insertion hole 124t.

When each of the fastening members TN is threadably inserted into the corresponding main body insertion hole 122n and is tightened to a position at which each of the fastening surfaces 122p contacts the corresponding contact surface 124u, the main body 120 and the main-body cover 124 are fastened together.

The stationary disk 14 is a circular disk member, a thickness direction of which coincides with the axial direction DRa. The stationary disk 14 has the opening surface 140 that is a front surface of the stationary disk 14 along which the drive disk 22 slides. The opening surface 140 is a contact surface that contacts a sliding surface 220 of the drive disk 22.

Preferably, the stationary disk 14 is made of a material that has a smaller coefficient of linear expansion and superior wear resistance in comparison to the material of the housing 12. The stationary disk 14 is made of a high-hardness material that has a hardness higher than that of the housing 12. Specifically, the stationary disk 14 is made of ceramic. The stationary disk 14 is a powder molded product that is formed by molding ceramic powder into a desired shape with a press machine. Only a portion of the stationary disk 14, which forms the opening surface 140, may be made of the material, such as the ceramic, which has the smaller coefficient of linear expansion and the superior wear resistance in comparison to the material of the housing 12.

Furthermore, as shown in FIG. 6, the stationary disk 14 is a passage forming portion that forms the first passage hole 141 and the second passage hole 142 which conduct the fluid therethrough. Therefore, in the valve device 10 of the present embodiment, the stationary disk 14, which is the passage forming portion, is formed as a separate member that is formed separately relative to the housing 12.

Furthermore, the third passage hole 143, which does not conduct the fluid, is formed at the stationary disk 14. Furthermore, the stationary disk 14 has: a stationary outer periphery 144 which is opposed to the main-body peripheral wall 122; and the rotation stop projection 145 which projects toward the main-body peripheral wall 122.

Each of the passage holes 141, 142, 143 is formed at a corresponding location of the stationary disk 14 which is spaced from the central axis CL of the shaft 18, so that each of the passage holes 141, 142, 143 does not overlap with the central axis CL of the shaft 18. Each of the passage holes 141, 142, 143 is a through-hole that is shaped in a form of a sector. Each of the first passage hole 141 and the second passage hole 142 serve as a communication passage that communicates between the inlet-side space 12d and the outlet-side space 12e. In contrast, the other side of the third passage hole 143, which is located on the other side in the axial direction DRa, is closed by the non-stepped portion 121b, so that the third passage hole 143 does not function as a communication passage that communicates between the inlet-side space 12d and the outlet-side space 12e. The shape of each of the passage holes 141, 142, 143 may be in another form, such as a form of circle, a form of ellipse instead of the form of sector.

Specifically, the first passage hole 141 is formed at a corresponding location of the stationary disk 14, which corresponds to the first outlet-side space, to enable communication of the first passage hole 141 with the first outlet-side space. Specifically, the second passage hole 142 is formed at a corresponding location of the stationary disk 14, which corresponds to the second outlet-side space, to enable communication of the second passage hole 142 with the second outlet-side space. The third passage hole 143 is placed at a location that corresponds to the non-stepped portion 121b, so that the third passage hole 143 is not communicated with the first outlet-side space and the second outlet-side space.

A stationary disk hole 146 is formed at generally a center part of the stationary disk 14. The stationary disk hole 146 is a stationary-side through-hole, through which the shaft 18 is inserted. An inner diameter of the stationary disk hole 146 is larger than the diameter of the shaft 18, so that the shaft 18 does not slide relative to the stationary disk hole 146. Specifically, a size of the stationary disk hole 146 is set such that a predetermined gap is formed between an inner periphery of the stationary disk hole 146 and the outer periphery of the shaft 18 to enable tilting of the shaft 18 in a state where the shaft 18 is inserted through the stationary disk hole 146.

The stationary outer periphery 144 forms an outer contour of the stationary disk 14. A portion of the stationary outer periphery 144, which forms the rotation stop projection 145, is opposed to the receiving groove 122f.

The rotation stop projection 145 is a rotation limiting portion that is fitted into the receiving groove 122f to limit rotation of the stationary disk 14 in the circumferential direction DRc. The rotation stop projection 145 is formed at a location that corresponds to the receiving groove 122f in the radial direction DRr at the time of placing the stationary disk 14 at the inside of the main body 120. The rotation stop projection 145 is formed such that the portion of the stationary outer periphery 144, which forms the rotation stop projection 145, projects further toward the radially outer side in the radial direction DRr in comparison to another portion of the stationary outer periphery 144, which does not form the rotation stop projection 145, and thereby the portion of the stationary outer periphery 144, which forms the rotation stop projection 145, projects away from the central axis CL.

The gasket 15, which seals a gap between the stationary disk 14 and the mounting portion 122a, is placed between the stationary disk 14 and the mounting portion 122a. The gasket 15 is made of rubber. The gasket 15 is received in the receiving groove 122b formed at the mounting portion 122a. The gasket 15 has at least two projections at a seal surface opposed to the stationary disk 14 and at least two projections at another seal surface opposed to the mounting portion 122a. Specifically, the gasket 15 has two projections that project in the axial direction DRa. Such a gasket 15 can be obtained by a simple method, for example, by forming recesses at a flat seal surface.

The drive device 16 is a device for outputting the rotational force. Although not depicted in the drawings, the drive device 16 includes: an electric motor which serves as a drive power source; and a gear arrangement which serves as a drive force transmission member and transmits the output of the electric motor to the shaft 18. For example, a servomotor or a brushless motor is used as the electric motor. The gear arrangement is formed by a gear mechanism that includes, for example, a helical gear or a spur gear. Although not depicted in the drawings, the electric motor is rotated according to a control signal outputted from a valve controller unit that is electrically connected to the electric motor. The valve controller unit is a computer that includes a memory (a non-transitory tangible storage medium) and a processor. The valve controller unit executes a computer program stored in the memory and also executes various control processes according to the computer program.

The shaft 18 is a rotatable column that is rotated about the predetermined central axis CL by the rotational force outputted from the drive device 16. The shaft 18 extends in the axial direction DRa. Two axial sides of the shaft 18, which are opposite to each other in the axial direction DRa, are rotatably supported by the housing 12. Specifically, the shaft 18 has a both-ends supported structure. The shaft 18 extends through the stationary disk 14 and the drive disk 22 and is rotatably supported related to the housing 12.

Specifically, at the inside of the main-body cover 124, one side of the shaft 18, which is located on the one side in the axial direction DRa, is rotatably supported by the bearing 124m, which is located on the radially inner side of the cover rigidity reducing parts 126 in the radial direction DRr. Furthermore, the other side of the shaft 18 in the axial direction DRa is supported by a bearing hole 121c formed at the bottom wall 121 of the main body 120. The bearing hole 121c is formed by a plain bearing. The bearing hole 121c may be formed by a ball bearing or the like instead of the plain bearing.

The shaft 18 includes: a shaft core 181 made of metal; and a holder 182 made of resin and is coupled to the shaft core 181. The shaft core 181 is coupled to the holder 182 such that the shaft core 181 is rotatable integrally with the holder 182. The shaft core 181 and the holder 182 are formed as an insert molded product that is formed integrally by insert molding.

The shaft core 181 includes the central axis CL of the shaft 18 and extends in the axial direction DRa. The shaft core 181 is a portion that becomes a center of rotation of the valve element 20. The shaft core 181 is formed by a rod member made of the metal to ensure a required degree of straightness of the shaft core 181.

The holder 182 is coupled to the one side of the shaft core 181, which is located on the one side in the axial direction DRa. The holder 182 is shaped in a bottomed tubular form. The shaft core 181 is coupled to an inside of a distal end part of the holder 182 which is located on the one side in the axial direction DRa. Furthermore, the distal end part of the holder 182, which projects to the outside of the housing 12, is coupled to the gear arrangement of the drive device 16.

The valve element 20 is rotated by the output of the drive device 16 about the central axis CL of the shaft 18. The valve element 20 increases or decreases an opening degree of each of the passage holes 141, 142 of the stationary disk 14 in response to the rotation of the shaft 18. As shown in FIG. 3, the valve element 20 includes: the drive disk 22, which serves as a rotor; and a lever 24, which couples the drive disk 22 to the shaft 18.

The drive disk 22 is the rotor which increases or decreases the opening degree of the first passage hole 141 and the opening degree of the second passage hole 142 in response to the rotation of the shaft 18. The opening degree of the first passage hole 141 is a degree of opening of the first passage hole 141. Here, the opening degree of the first passage hole 141 in a full-opening state thereof is indicated as 100%, and the opening degree of the first passage hole 141 in a full-closing state thereof is indicated as 0%. The full-opening state of the first passage hole 141 is a state where the first passage hole 141 is not closed by the drive disk 22 at all. The full-closing state of the first passage hole 141 is a state where a whole of the first passage hole 141 is closed by the drive disk 22. The opening degree of the second passage hole 142 is the same as the opening degree of the first passage hole 141.

The drive disk 22 is a circular disk member, a thickness direction of which coincides with the axial direction DRa. The drive disk 22 is placed in the inlet-side space 12d such that the drive disk 22 is opposed to the stationary disk 14 in the axial direction DRa. The drive disk 22 has the sliding surface 220 that is opposed to the opening surface 140 of the stationary disk 14. The sliding surface 220 is a seal surface that seals the opening surface 140 of the stationary disk 14.

Preferably, the drive disk 22 is made of a material that has a smaller coefficient of linear expansion and superior wear resistance in comparison to the material of the housing 12. The drive disk 22 is made of a high-hardness material that has a hardness higher than that of the housing 12. Specifically, the drive disk 22 is made of ceramic. The drive disk 22 is a powder molded product that is formed by molding ceramic powder into a desired shape with a press machine. Only a portion of the drive disk 22, which forms the sliding surface 220, may be made of the material, such as the ceramic, which has the smaller coefficient of linear expansion and the superior wear resistance in comparison to the material of the housing 12.

Here, the ceramic is a material that has a small coefficient of linear expansion and shows little dimensional change upon absorption of water, and has excellent wear resistance. When the drive disk 22 is made of the ceramic, the positional relationship between the drive disk 22 and the shaft 18, and the positional relationship between the drive disk 22 and the housing 12 are stabilized. As a result, a required accuracy of the flow rate control can be ensured, and unintended fluid leakage can be limited.

Furthermore, the drive disk 22 has a rotor hole 221 that is placed at a location which is eccentric to the central axis CL of the shaft 18. The rotor hole 221 is a through-hole that extends through the drive disk 22 in the axial direction DRa, and the rotor hole 221 serves as a flow passage through which the fluid is conducted. The rotor hole 221 is formed at the location which overlaps with the first passage hole 141 and the second passage hole 142 in the axial direction DRa when the drive disk 22 is rotated about the central axis CL of the shaft 18.

The drive disk 22 has a shaft insertion hole 223 at a substantially center of the drive disk 22. The shaft insertion hole 223 is a drive-side insertion hole through which the shaft 18 is inserted. An inner diameter of the shaft insertion hole 223 is larger than a diameter of the shaft 18, so that the shaft 18 does not slide relative to the shaft insertion hole 223. Specifically, a predetermined gap is formed between an inner periphery of the shaft insertion hole 223 and the outer periphery of the shaft 18 to enable tilting of the shaft 18 in a state where the shaft 18 is inserted through the shaft insertion hole 223.

In the valve device 10, when the drive disk 22 is rotated to a position, at which the rotor hole 221 overlaps with the first passage hole 141 in the axial direction DRa, the first passage hole 141 is opened. Also, in the valve device 10, when the drive disk 22 is rotated to a position, at which the rotor hole 221 overlaps with the second passage hole 142 in the axial direction DRa, the second passage hole 142 is opened.

The drive disk 22 is configured to adjust a flow rate ratio between the fluid, which passes through the first passage hole 141, and the fluid, which passes through the second passage hole 142. That is, the drive disk 22 is configured such that when the opening degree of the first passage hole 141 is increased, the opening degree of the second passage hole 142 is decreased.

The lever 24 is a coupling member that couples between the shaft 18 and the drive disk 22. The lever 24 is fixed to the drive disk 22 and couples between the drive disk 22 and the shaft 18 such that the drive disk 22 and the shaft 18 are integrally rotatable in a state where the drive disk 22 is displaceable in the axial direction DRa.

The compression spring 26 is an urging member that urges the valve element 20 to the stationary disk 14. The compression spring 26 is resiliently deformed in the axial direction DRa of the shaft 18. The compression spring 26 is placed at the inside of the housing 12 in a state where the compression spring 26 is compressed in the axial direction DRa such that one end part of the compression spring 26, which is located on the one side in the axial direction DRa, contacts the shaft 18, and the other end part of the compression spring 26, which is located on the other side in the axial direction DRa, contacts the valve element 20. Specifically, the compression spring 26 is placed such that the one end part of the compression spring 26, which is located on the one side in the axial direction DRa, contacts an inside of the holder 182, and the other end part of the compression spring 26, which is located on the other side in the axial direction DRa, contacts the lever 24. The compression spring 26 is not fixed to at least one of the valve element 20 and the shaft 18, so that compression spring 26 does not function as a torsion spring.

The valve element 20 is urged against the stationary disk 14 by the compression spring 26, so that a contact state, in which the opening surface 140 of the stationary disk 14 and the sliding surface 220 of the drive disk 22 contact with each other, is maintained. This contact state is a state where the opening surface 140 of the stationary disk 14 and the sliding surface 220 of the drive disk 22 make surface-to-surface contact with each other. That is, the valve device 10 can maintain the orientation of the drive disk 22 such that the drive disk 22 is kept in contact with the stationary disk 14.

Specifically, the compression spring 26 is arranged to surround the central axis CL of the shaft 18. In other words, the shaft 18 is placed at an inside of the compression spring 26. With this configuration, it is possible to limit uneven distribution of the load of the compression spring 26 against the drive disk 22 in the circumferential direction DRc of the shaft 18, and thereby the contact state of the sliding surface 220 relative to the opening surface 140 can be easily maintained.

The first torsion spring 28 is a spring that urges the shaft 18 against the housing 12 in the circumferential direction DRc around the central axis CL of the shaft 18. The first torsion spring 28 is placed between the housing 12 and the shaft 18.

Basically, the first torsion spring 28 is used in a state where the first torsion spring 28 is twisted in the circumferential direction DRc and is thereby resiliently deformed. An urging force of the first torsion spring 28 is applied to the shaft 18 in both a rotating state, in which the shaft 18 is rotated, and a stop state, in which the shaft 18 is not rotated. The urging force of the first torsion spring 28 is transmitted as a rotational force from the gear arrangement of the drive device 16 to the electric motor through the shaft 18. Therefore, by placing the first torsion spring 28 between the housing 12 and the shaft 18, rattling in the circumferential direction DRc between the drive device 16 and the shaft 18 is limited. The first torsion spring 28 is merely twisted in the circumferential direction DRc and is not compressed in the axial direction DRa.

The second torsion spring 30 is a spring that urges the lever 24 against the shaft 18 in the circumferential direction DRc. The second torsion spring 30 is placed between the shaft 18 and the lever 24. An axial dimension of the second torsion spring 30 measured in the axial direction DRa is smaller than that of the first torsion spring 28, and a radial dimension of the second torsion spring 30 measured in the radial direction DRr is smaller than that of the first torsion spring 28.

Basically, the second torsion spring 30 is used in a state where the second torsion spring 30 is twisted in the circumferential direction DRc and is thereby resiliently deformed. An urging force of the second torsion spring 30 is applied to the lever 24 in both a rotating state, in which the shaft 18 is rotated, and a stop state, in which the shaft 18 is not rotated. The urging force of the second torsion spring 30 is transmitted to the drive disk 22 as a rotational force through the lever 24. Therefore, by placing the second torsion spring 30 between the shaft 18 and the lever 24, rattling in the circumferential direction DRc between the shaft 18 and the lever 24 is limited. Furthermore, since the lever 24 is fixed to the drive disk 22, rattling in the circumferential direction between the shaft 18 and the drive disk 22 is limited by the second torsion spring 30. The second torsion spring 30 is merely twisted in the circumferential direction DRc and is not compressed in the axial direction DRa.

In the valve device 10, the shaft 18, the lever 24 and the shaft 18 are assembled as a sub-assembly by engaging the shaft 18 to the lever 24 in a state where the second torsion spring 30 is interposed between the shaft 18 and the lever 24.

Next, details of each main-body rigidity reducing part 125 and each cover rigidity reducing part 126 will be described. The main-body rigidity reducing part 125 of the present embodiment is formed by one space (single space) that is formed at the main-body connecting portion 122k. Specifically, the one main-body rigidity reducing part 125 is formed at the main-body connecting portion 122k, so that the space is formed at the inside of the main-body connecting portion 122k.

The space, which is formed by the main-body rigidity reducing part 125, is a space that is filled with the air. In this way, the rigidity of the main-body connecting portion 122k is reduced in comparison to a case where the main-body rigidity reducing part 125 is absent at the main-body connecting portion 122k.

Furthermore, the cover rigidity reducing part 126 of the present embodiment is formed by one space (single space) that is formed at the cover connecting portion 124n. Specifically, the one cover rigidity reducing part 126 is formed at the cover connecting portion 124n, so that the space is formed at the inside of the cover connecting portion 124n.

The space, which is formed by the cover rigidity reducing part 126, is a space that is filled with the air. Therefore, the rigidity of the cover connecting portion 124n is reduced in comparison to a case where the cover rigidity reducing part 126 is absent at the cover connecting portion 124n.

The main-body rigidity reducing part 125 extends from one end of the main-body connecting portion 122k, which is located on the one side in the axial direction DRa, toward the other end of the main-body connecting portion 122k, which is located on the other side in the axial direction DRa, without penetrating through the other end part of the main-body connecting portion 122k. Specifically, the main-body rigidity reducing part 125 is shaped in a bottomed tubular form (bottomed form) and has an opening on the one side in the axial direction DRa and a closed bottom on the other side in the axial direction DRa.

A cross-section of the main-body connecting portion 122k, which is perpendicular to the axial direction DRa, is set such that a cross-sectional area of a portion of the main-body connecting portion 122k, at which the main-body rigidity reducing part 125 is formed, is larger than a cross-sectional area of another portion of the main-body connecting portion 122k, at which the main-body rigidity reducing part 125 is absent. Specifically, the cross-section of the main-body connecting portion 122k, which is perpendicular to the axial direction DRa, is set such that an opening cross-sectional area of the main-body rigidity reducing part 125 is larger than the cross-sectional area of the other portion, at which the main-body rigidity reducing part 125 is absent. The main-body rigidity reducing part 125 is formed such that the opening cross-sectional area of the main-body rigidity reducing part 125 is constant along the main-body rigidity reducing part 125 from the one side to the other side in the axial direction DRa.

It is desirable that in the main-body connecting portion 122k, a depth of the main-body rigidity reducing part 125 is larger than a bottom thickness of a connecting bottom portion 122r, which is a portion located on the other side of the main-body rigidity reducing part 125 in the axial direction DRa. Specifically, it is desirable that a size of the main-body rigidity reducing part 125 measured in the axial direction DRa is at least twice larger than a size of the connecting bottom portion 122r measured in the axial direction DRa. In the present embodiment, the main-body rigidity reducing part 125 is formed such that a ratio of the size of the main-body rigidity reducing part 125 measured in the axial direction DRa relative to the size of the connecting bottom portion 122r measured in the axial direction DRa is at least four times.

The cover rigidity reducing part 126 extends through the cover connecting portion 124n from one end of the cover connecting portion 124n, which is located on the one side in the axial direction DRa, to the other end of the cover connecting portion 124n, which is located on the other side in the axial direction DRa. Specifically, the cover rigidity reducing part 126 extends through the outer connecting portion 124s from one end of the outer connecting portion 124s, which is located on the one side in the axial direction DRa, to the other end of the outer connecting portion 124s, which is located on the other side in the axial direction DRa. That is, the cover rigidity reducing part 126 is a through-hole that extends through the outer connecting portion 124s.

The cover rigidity reducing part 126 is formed at a location, at which the cover rigidity reducing part 126 overlaps with the main-body rigidity reducing part 125 in the axial direction DRa. Furthermore, the size of the cover rigidity reducing part 126 is set such that the cover rigidity reducing part 126 overlaps with the main-body rigidity reducing part 125 in the axial direction DRa.

Furthermore, a cross-section of the outer connecting portion 124s, which is perpendicular to the axial direction DRa, is set such that a cross-sectional area of a portion of the outer connecting portion 124s, at which the cover rigidity reducing part 126 is formed, is larger than a cross-sectional area of another portion of the outer connecting portion 124s, at which the cover rigidity reducing part 126 is absent. Specifically, the cross-section of the outer connecting portion 124s, which is perpendicular to the axial direction DRa, is set such that an opening cross-sectional area of the cover rigidity reducing part 126 is larger than the cross-sectional area of the other portion, at which the cover rigidity reducing part 126 is absent. The cover rigidity reducing part 126 is formed such that the opening cross-sectional area of the cover rigidity reducing part 126 is constant along the cover rigidity reducing part 126 from the one side to the other side in the axial direction DRa.

Next, an operation of the valve device 10 of the present embodiment will be described. As shown in FIGS. 1 to 4, in the valve device 10, the fluid flows from the inlet 12a into the inlet-side space 12d, as indicated by an arrow Fi. Then, in a case where the first passage hole 141 is opened, the fluid flows from the inlet-side space 12d to the first outlet-side space through the first passage hole 141. The fluid, which flows into the first outlet-side space, flows from the first outlet-side space to the outside of the valve device 10 through the first outlet 12b, as indicated by an arrow Flo. In this case, the flow rate of the fluid, which passes through the first passage hole 141, is determined according to the opening degree of the first passage hole 141. That is, the flow rate of the fluid, which flows from the inlet 12a to the first outlet 12b through the first passage hole 141, is increased when the opening degree of the first passage hole 141 is increased.

In contrast, in another case where the second passage hole 142 is opened, the fluid flows from the inlet-side space 12d to the second outlet-side space through the second passage hole 142. The fluid, which flows into the second outlet-side space, flows from the second outlet-side space to the outside of the valve device 10 through the second outlet 12c, as indicated by an arrow F2o. In this case, the flow rate of the fluid, which passes through the second passage hole 142, is determined according to the opening degree of the second passage hole 142. That is, the flow rate of the fluid, which flows from the inlet 12a to the second outlet 12c through the second passage hole 142, is increased when the opening degree of the second passage hole 142 is increased.

Next, fastening between the main body 120 and the main-body cover 124 will be described. As described above, the main body 120 and the main-body cover 124 are made of the resin material. In contrast, the tapping screws made of the metal material are respectively used as the fastening members TN, which fasten the main-body cover 124 to the main body 120. When each of the fastening members TN is threadably inserted into the corresponding main body insertion hole 122n and is tightened to a position at which each of the fastening surfaces 122p contacts the corresponding contact surface 124u, the main body 120 and the main-body cover 124 are fastened together.

Now, there will be described influences on the fastening between the main body 120 and the main-body cover 124 in a case where a degree of flatness of one or more of the three fastening surfaces 122p and the three contact surfaces 124u is lower than a designed degree of flatness (designed accuracy) and a case where surface heights of the three fastening surfaces 122p and surface heights of the three contact surfaces 124u vary from each other.

In a case where the degree of flatness of the fastening surface 122p and/or the contact surface 124u is lower than the designed degree of flatness (designed accuracy), the main body 120 and the main-body cover 124 may possibly be assembled together such that at least one of the main body 120 and the main-body cover 124 is tilted relative to the axial direction DRa at the time of fastening the fastening member TN until the fastening surface 122p and the contact surface 124u contact each other. Furthermore, in the case where the surface heights of the three fastening surfaces 122p and the surface heights of the three contact surfaces 124u vary from each other, the main body 120 and the main-body cover 124 may possibly be assembled in a state where at least one of the main body 120 and the main-body cover 124 is tilted such that a portion of one of the fastening surface 122p and the contact surface 124u opposed to each other is positioned on the lower side of a portion of the other one of the fastening surface 122p and the contact surface 124u.

When the fastening members TN are tightened in the state where at least one of the main body 120 and the main-body cover 124 is tilted relative to the axial direction DRa, an excessive load is applied to the fastening surface 122p and the contact surface 124u. Thereby, at least one of the main body 120 and the main-body cover 124 may possibly be deformed along the tilting direction of the at least one of the main body 120 and the main-body cover 124. In the present embodiment, the main body 120 and the main-body cover 124, which are made of the resin material, are fastened by the fastening members TN, which are made of the metal material. Therefore, the main body 120 and the main-body cover 124 are more likely to be deformed than the fastening members TN.

When a distance between the seal installation portion 122e and the seal support portion 124f, which resiliently deform the seal member 13 in the axial direction DRa, is increased in response to deformation of at least one of the main body 120 and the main-body cover 124 in comparison to the distance between the seal installation portion 122e and the seal support portion 124f before the time of deformation, the amount of resilient deformation of the seal member 13 is reduced. In this case, when the seal member 13 cannot be resiliently deformed to the shape for sealing between the main body 120 and the main-body cover 124, the gap between the main body 120 and the main-body cover 124 may not be sealed. Therefore, the inlet-side space 12d cannot be closed relative to the outside of the valve device 10, and thereby it is difficult ensure the required degree of sealing of the inlet-side space 12d.

Furthermore, when the main body 120 and the main-body cover 124 are fastened by fastening the screws in the state where at least one of the main body 120 and the main-body cover 124 is tilted relative to the axial direction DRa, a crack may possibly be generated at least one of the main body 120 and the main-body cover 124, which are made of the resin. When the crack is generated to extend from the outside to the inside of the main-body peripheral wall 122, it is difficult to ensure the required degree of sealing of the inlet-side space 12d.

The valve device 10 needs to accurately adjust the flow rate of the fluid, so that the required degree of sealing of the inlet-side space 12d needs to be ensured. However, it is difficult to ensure the required degree of sealing of the inlet-side space 12d in the case where the degree of flatness of one or more of the three fastening surfaces 122p and the three contact surfaces 124u is lower than the designed degree of flatness (designed accuracy) or the case where surface heights of the three fastening surfaces 122p and surface heights of the three contact surfaces 124u vary from each other.

The main body 120 and the main-body cover 124 are injection molded by filling the resin material into the mold and solidifying the resin material into the desired shape, so that it is difficult for the main body 120 and the main-body cover 124 to achieve a high degree of flatness or uniform surface heights in comparison with the case of processing the metal material.

In contrast, in the present embodiment, in the valve device 10, the main-body rigidity reducing part 125 is formed at each of the main-body connecting portions 122k. Furthermore, the cover rigidity reducing part 126 is formed at each of the cover connecting portions 124n. Therefore, the main-body connecting portion 122k tends to be deformed when the excessive load is applied to the fastening surface 122p at the time of fastening the main body 120 and the main-body cover 124 together in the case where the degree of flatness of one or more of the three fastening surfaces 122p and the three contact surfaces 124u is lower than the designed degree of flatness (designed accuracy) or the case where surface heights of the fastening surfaces 122p and surface heights of the contact surfaces 124u vary from each other. Likewise, when the excessive load is applied to the contact surface 124u, the cover connecting portion 124n tends to be deformed.

In contrast, at the main body 120, the main-body peripheral wall 122, which is located on the radially inner side of the main-body connecting portion 122k, is less likely to be deformed. Furthermore, at the main-body cover 124, the plate portion 124a and the rib portion 124b, which are located on the radially inner side of the cover connecting portions 124n in the radial direction DRr, is less likely to be deformed. Therefore, it is possible to limit an increase in the distance between the seal installation portion 122e and the seal support portion 124f caused by the deformation of at least one of the main body 120 and the main-body cover 124. Therefore, it is possible to limit the decrease in the amount of resilient deformation of the seal member 13 caused by the deformation of at least one of the main body 120 and the main-body cover 124, and thereby it is possible to ensure the required degree of sealing of the inlet-side space 12d.

Furthermore, the valve device 10 of the present embodiment can achieve the following advantages.

(1) The rigidity reducing structures are implemented by providing the main-body rigidity reducing part 125 and the cover rigidity reducing part 126, each of which is the space, to the main-body connecting portion 122k and the cover connecting portion 124n, respectively. In this way, the rigidity reducing structures can be more easily implemented in comparison to a case where each of the main-body rigidity reducing parts 125 is formed by a member, which has a lower rigidity in comparison to the main-body peripheral wall 122, or a case where each of the cover rigidity reducing parts 126 is formed by a member, which has a lower rigidity in comparison to the cover peripheral wall 124d.

(2) The location of each of the fastening surfaces 122p is displaced from the installation location of the seal member 13 toward the one side in the axial direction DRa. According to this, the distance between the seal member 13 and the fastening surface 122p in the axial direction DRa can be increased in comparison to a case where the fastening surface 122p is placed at the same location as the installation location of the seal member 13. Therefore, even when at least one of the main body 120 and the main-body cover 124 is deformed in response to application of the excessive load to the fastening surface 122p and the contact surface 124u, the seal member 13 is less likely to be deformed.

(3) The location of the fastening surface 122p is displaced from the installation location of the main-body connecting portion 122k toward the one side in the axial direction DRa. According to this, the distance between the main-body connecting portion 122k and the fastening surface 122p in the axial direction DRa can be increased in comparison to a case where the fastening surface 122p is placed at the same location as the installation location of the main-body connecting portion 122k.

Thus, at the time of applying the excessive load to the fastening surface 122p, the main-body connecting portion 122k is more easily deformed in comparison to the case where the above-described configuration is absent. Therefore, the excessive load can be allowed by the main-body connecting portion 122k. Therefore, even in the case where the excessive load is applied to the fastening surface 122p, the portion of the main body 120, which is located on the radially inner side of the main-body connecting portion 122k in the radial direction DRr, is less likely to be deformed.

(4) The valve device 10 includes the shaft 18 that is rotated integrally with the valve element 20. Furthermore, the main-body cover 124 has the housing boss portion 124c. The housing boss portion 124c rotatably supports the one axial side of the shaft 18 located on the one side in the axial direction DRa in the state where the shaft 18 is inserted through the housing boss portion 124c. The housing boss portion 124c is located on the radially inner side of the cover rigidity reducing part 126 in the radial direction DRr. Furthermore, the main-body cover 124 has the shaft seal 124h which seals the gap between the outer periphery of the shaft 18 and the inner periphery of the housing boss portion 124c.

In a case where the main-body cover 124 is fastened in the state where the main-body cover 124 is tilted relative to the axial direction DRa, the shaft 18, which is supported by the main-body cover 124, may possibly be tilted relative to the shaft seal 124h. In this case, uneven wearing of the shaft seal 124h caused by the rotation of the shaft 18 may possibly occur. However, according to the present embodiment, in the valve device 10, the main-body rigidity reducing part 125 is formed at each of the main-body connecting portions 122k, and the cover rigidity reducing part 126 is formed at each of the cover connecting portions 124n. Therefore, In the case where the main-body cover 124 is fastened in the state where the main-body cover 124 is tilted relative to the axial direction DRa, the tilting of the shaft 18 relative to the shaft seal 124h is limited. Thus, uneven wearing of the shaft seal 124h caused by the rotation of the shaft 18 is limited.

(5) The predetermined gap is formed between the inner periphery of the shaft insertion hole 223 and the outer periphery of the shaft 18 to enable tilting of the shaft 18 in the state where the shaft 18 is inserted through the shaft insertion hole 223.

In a case where the main-body cover 124 is fastened in the state where the main-body cover 124 is tilted relative to the axial direction DRa, the shaft 18, which is supported by the main-body cover 124, may possibly be tilted relative to the axial direction DRa. Furthermore, in order to avoid interference between the inner periphery of the shaft insertion hole 223 and the outer periphery of the shaft 18, it is necessary to increase the predetermined gap between the inner periphery of the shaft insertion hole 223 and the outer periphery of the shaft 18 when the amount of tilt of the shaft 18 is increased.

However, according to the present embodiment, in the valve device 10, the main-body rigidity reducing part 125 is formed at each of the main-body connecting portions 122k, and the cover rigidity reducing part 126 is formed at each of the cover connecting portions 124n. Therefore, in the case where the main-body cover 124 is fastened in the state where the main-body cover 124 is tilted relative to the axial direction DRa, the tilting of the shaft 18 relative to the shaft seal 124h is limited.

Therefore, it is no longer required to unnecessarily increase the predetermined gap between the inner periphery of the shaft insertion hole 223 and the outer periphery of the shaft 18 to avoid the interference between the shaft insertion hole 223 and the shaft 18.

Thus, in comparison to the case where the gap between the shaft 18 and the shaft insertion hole 223 is unnecessarily increased, it is possible to limit a positional deviation between the rotor hole 221 of the drive disk 22 and the first passage hole 141 and the second passage hole 142 of the stationary disk 14. In this way, the flow rate of the fluid, which flows in the first passage hole 141, and the flow rate of the fluid, which flows in the second passage hole 142, can be accurately adjusted.

(6) In the present embodiment, the tapping screw, which is made of the metal material, is used as the fastening member TN for fastening the main body 120 and the main-body cover 124 together. In the case where the main body 120 and the main-body cover 124 are fastened together by threadably inserting the tapping screw into the main-body fastening portion 122m, the crack may possibly be generated at the main-body fastening portion 122m.

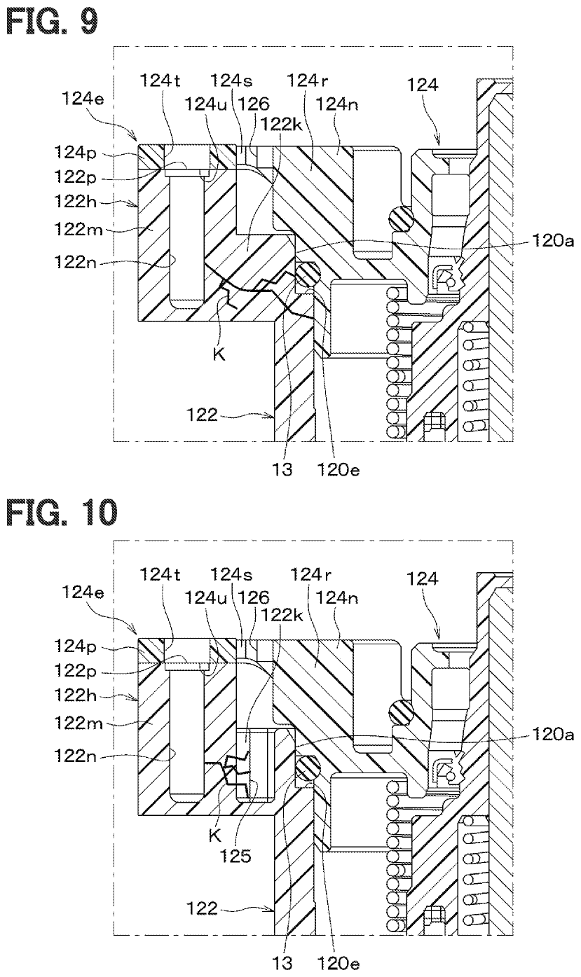

Here, it is assumed that a crack K is generated from the main-body fastening portion 122m to the main-body peripheral wall 122 through the main-body connecting portion 122k in a case where the main-body rigidity reducing part 125, which is formed by the space, is not present at the main-body connecting portion 122k, as shown in FIG. 9. When the crack K is generated and extends from the outside to the inside of the main-body peripheral wall 122, it is difficult to ensure the required degree of sealing of the inlet-side space 12d.

In contrast, in the valve device 10 of the present embodiment, the main-body rigidity reducing part 125, which is formed by the space, is provided at each of the main-body connecting portions 122k. Therefore, even when the crack K is generated from the main-body fastening portion 122m toward the main-body peripheral wall 122 through the main-body connecting portion 122k in response to the threadably inserting of the tapping screw, the crack K is less likely to be generated beyond the main-body rigidity reducing part 125 toward the inner side in the radial direction DRr, as shown in FIG. 10. Thus, even when the crack is generated at the main-body fastening portion 122m by the threadably inserting of the tapping screw, it is possible to limit the leakage of the fluid to the outside of the valve device 10 through the crack.

(7) The main body 120 and the main-body cover 124 are made of the resin. Furthermore, the main-body rigidity reducing part 125 is shaped in the bottomed tubular form and has the opening on the one side in the axial direction DRa and the closed bottom on the other side in the axial direction DRa. With this configuration, at the time of manufacturing the main body 120 by the rein molding, the mold can be easily removed from the main body 120. Therefore, generation of burrs at the time of the resin molding can be limited.

### OTHER EMBODIMENTS

Although the representative embodiment of the present disclosure has been described above, the present disclosure is not limited to the above-described embodiment and can be variously modified, for example, as follows.

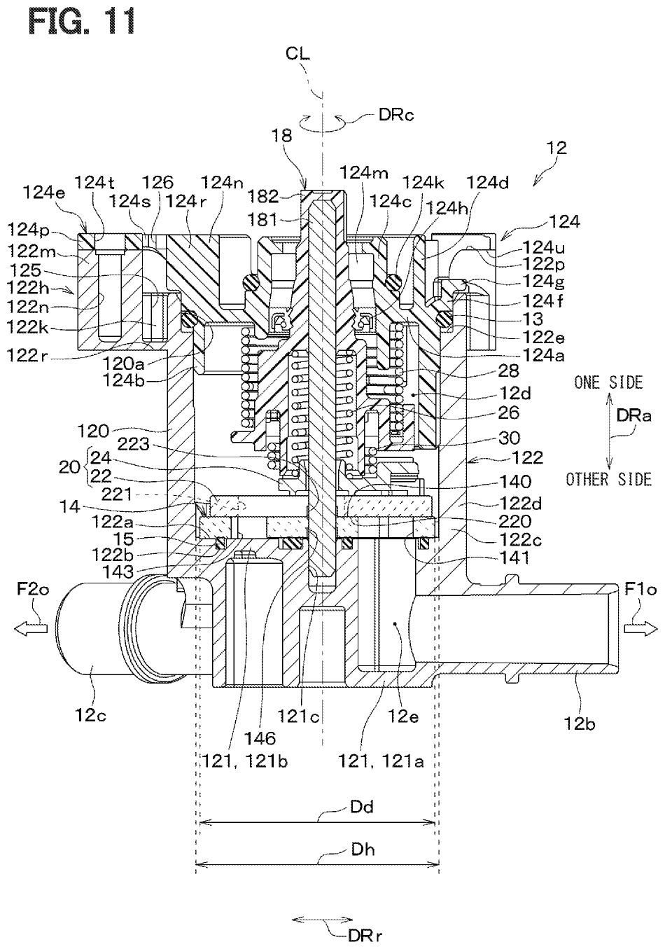

In the embodiment described above, there is described the example where both of the main body 120 and the main-body cover 124 are made of the resin. However, the present disclosure is not limited to this. For example, the main body 120 and the main-body cover 124 may be formed by different types of members such that the rigidity of one of the main body 120 and the main-body cover 124 is smaller than the rigidity of the other one of the main body 120 and the main-body cover 124. Specifically, for example, as shown in FIG. 11, the main body 120 may be made of metal, and the main-body cover 124 may be made of resin that has the rigidity lower than that of the metal.

In this way, even when the excessive load is applied to the fastening surface 122p and the contact surface 124u at the time of fastening the main body 120 and the main-body cover 124 together, the main body 120 is less likely to be deformed in comparison to the main-body cover 124 which has the lower rigidity. Therefore, in comparison to the case where the main body 120 and the main-body cover 124 are respectively formed by the members which have the same rigidity, it is possible to limit deformation of the other one, which has the higher rigidity, in response to deformation of the one, which has the lower rigidity. Thus, the required degree of sealing of the receiving space can be more easily ensured.

In the embodiment described above, there is described the example where main-body rigidity reducing part 125 is formed as the rigidity reducing structure at each of the main-body connecting portions 122k, and the cover rigidity reducing part 126 is formed as the rigidity reducing structure at each of the cover connecting portions 124n. However, the present disclosure is not limited to this. For example, the rigidity reducing structure may be configured such that the main-body rigidity reducing part 125 is formed only at each of the main-body connecting portions 122k, and the cover rigidity reducing part 126 is not formed at each of the cover connecting portions 124n. Furthermore, the rigidity reducing structure may be configured such that the main-body rigidity reducing part 125 is not formed at each of the main-body connecting portions 122k, and the cover rigidity reducing part 126 is formed only at each of the cover connecting portions 124n.

In the embodiment described above, there is described the example where the space is formed at each of the main-body rigidity reducing parts 125 and the cover rigidity reducing parts 126 while the inside of the space is empty. For example, the main-body rigidity reducing part 125 may be configured such that the inside of the space, which is formed by the main-body rigidity reducing part 125, is filed with a member which has a rigidity that is lower than the rigidity of the main-body connecting portion 122k. Furthermore, the cover rigidity reducing part 126 may be configured such that the inside of the space, which is formed by the cover rigidity reducing part 126, is filed with a member which has a rigidity that is lower than the rigidity of the cover connecting portion 124n.

In the embodiment described above, there is described the example where the main-body rigidity reducing part 125 is the one bottomed tubular hole (single bottomed tubular hole) formed at the main-body connecting portion 122k. However, the present disclosure is not limited to this. Furthermore, there is described the example where the cover rigidity reducing part 126 is the one through-hole (single bottomed tubular hole) formed at the cover connecting portion 124n. However, the present disclosure is not limited to this.

The main-body rigidity reducing part 125 may be appropriately changed as long as the main-body rigidity reducing part 125 reduces the rigidity of the main-body connecting portion 122k. The cover rigidity reducing part 126 may be appropriately changed as long as the cover rigidity reducing part 126 reduces the rigidity of the cover connecting portion 124n.

For example, each of the main-body rigidity reducing part 125 and the cover rigidity reducing part 126 may be formed by a plurality of through-holes. Each of the main-body rigidity reducing part 125 and the cover rigidity reducing part 126 may be formed by a space where the opening cross-sectional area is not constant along the space from the one side to the other side in the axial direction DRa. Furthermore, the cover rigidity reducing part 126 may be shaped in a bottomed tubular form ((bottomed form) and has an opening on the one side in the axial direction DRa and a closed bottom on the other side in the axial direction DRa.

Needless to say, in the above-described embodiments, the elements of each embodiment are not necessarily essential except when it is clearly indicated that they are essential and when they are clearly considered to be essential in principle.

In each of the above embodiments, when a numerical value such as the number, numerical value, amount, range or the like of the constituent elements of the embodiment is mentioned, the present disclosure should not be limited to such a numerical value unless it is clearly stated that it is essential and/or it is required in principle.

In each of the above embodiments, when the shape, positional relationship or the like of the constituent elements of the embodiment is mentioned, the present disclosure should not be limited such a shape or positional relationship unless it is clearly stated that it is essential and/or it is required in principle.

What is claimed is:

1. A valve device comprising:
a drive device that is configured to output a rotational force;
a valve element that has a flow passage which is configured to conduct a fluid through the flow passage, wherein the valve element is configured to adjust a flow rate of the fluid flowing in the flow passage when the valve element is rotated about a predetermined central axis by the rotational force outputted from the drive device;
a housing main body that has:
a main-body peripheral wall which surrounds the predetermined central axis and forms a receiving space, wherein the receiving space receives the valve element; and
an opening which is formed at the housing main body on one side in an axial direction of the predetermined central axis;
a main-body cover that has a cover peripheral wall which surrounds the predetermined central axis, wherein the main-body cover is fastened to the housing main body and thereby closes the receiving space; and
a seal member that is resiliently deformed between the housing main body and the main-body cover to seal a gap between the housing main body and the main-body cover, wherein:
the housing main body has:
a main-body connecting portion that radially outwardly extends from the main-body peripheral wall to a location which is on a radially outer side of the seal member in a radial direction of the predetermined central axis; and
a main-body fastening portion that is joined to a radially outer end part of the main-body connecting portion and has a fastening surface which contacts the main-body cover;
the main-body cover has:
a cover connecting portion that radially outwardly extends from the cover peripheral wall to a location which is on the radially outer side of the seal member in the radial direction of the predetermined central axis; and
a cover fastening portion that is joined to a radially outer end part of the cover connecting portion and has a contact surface which contacts the fastening surface;
at least one of the housing main body and the main-body cover has a corresponding one of:
a rigidity reducing structure that includes a main-body rigidity reducing part that reduces a rigidity of the main-body connecting portion in comparison to a case where the main-body rigidity reducing part is absent at the main-body connecting portion; and
a rigidity reducing structure that includes a cover rigidity reducing part that reduces a rigidity of the cover connecting portion in comparison to a case where the cover rigidity reducing part is absent at the cover connecting portion;
at least one of the rigidity reducing structures is a structure that has a space which reduces the rigidity of a corresponding one of the main-body connecting portion and the cover connecting portion; and
a location of the fastening surface is displaced from an installation location of the seal member in the axial direction of the predetermined central axis.

2. The valve device according to claim 1, comprising a shaft that is configured to be rotated integrally with the valve element about the predetermined central axis, wherein:
the main-body cover has:
a shaft support portion that is located on a radially inner side of the cover rigidity reducing part in the radial direction of the predetermined central axis and rotatably supports one axial side of the shaft located on the one side in the axial direction in a state where the shaft is inserted through the shaft support portion; and
a shaft seal that seals a gap between an outer periphery of the shaft and an inner periphery of the shaft support portion.

3. The valve device according to claim 2, comprising a stationary disk that has at least one passage hole which is configured to conduct the fluid through the at least one passage hole, wherein:
the valve element includes a rotor that has:
the flow passage which is placed at a location that overlaps with the at least one passage hole in the axial direction of the predetermined central axis; and
a shaft insertion hole through which the shaft is inserted, wherein the rotor is configured to adjust a flow rate of the fluid, which flows in the at least one passage hole, when the rotor is rotated about the predetermined central axis in response to rotation of the shaft to change an overlapping range between the at least one passage hole and the flow passage; and
a predetermined gap is formed between an inner periphery of the shaft insertion hole and the outer periphery of the shaft.

4. The valve device according to claim 1, wherein the housing main body and the main-body cover are fastened together by a tapping screw that is inserted into the main-body fastening portion and the cover fastening portion.

5. The valve device according to claim 1, wherein:
the housing main body and the main-body cover are made of resin; and
at least one of the main-body rigidity reducing part and the cover rigidity reducing part is in a bottomed form and has an opening on one side and a closed bottom on an opposite side that is opposite to the one side.

6. A valve device comprising:
a drive device that is configured to output a rotational force;
a valve element that has a flow passage which is configured to conduct a fluid through the flow passage, wherein the valve element is configured to adjust a flow rate of the fluid flowing in the flow passage when the valve element is rotated about a predetermined central axis by the rotational force outputted from the drive device;
a housing main body that has:
a main-body peripheral wall which surrounds the predetermined central axis and forms a receiving space, wherein the receiving space receives the valve element; and
an opening which is formed at the housing main body on one side in an axial direction of the predetermined central axis;
a main-body cover that has a cover peripheral wall which surrounds the predetermined central axis, wherein the main-body cover is fastened to the housing main body and thereby closes the receiving space; and
a seal member that is resiliently deformed between the housing main body and the main-body cover to seal a gap between the housing main body and the main-body cover, wherein:
the housing main body has:
a main-body connecting portion that radially outwardly extends from the main-body peripheral wall to a location which is on a radially outer side of the seal member in a radial direction of the predetermined central axis; and
a main-body fastening portion that is joined to a radially outer end part of the main-body connecting portion and has a fastening surface which contacts the main-body cover;
the main-body cover has:
a cover connecting portion that radially outwardly extends from the cover peripheral wall to a location which is on the radially outer side of the seal member in the radial direction of the predetermined central axis; and
a cover fastening portion that is joined to a radially outer end part of the cover connecting portion and has a contact surface which contacts the fastening surface;
at least one of the housing main body and the main-body cover has a corresponding one of:
a rigidity reducing structure that includes a main-body rigidity reducing part that reduces a rigidity of the main-body connecting portion in comparison to a case where the main-body rigidity reducing part is absent at the main-body connecting portion; and
a rigidity reducing structure that includes a cover rigidity reducing part that reduces a rigidity of the cover connecting portion in comparison to a case where the cover rigidity reducing part is absent at the cover connecting portion;
at least one of the rigidity reducing structures is a structure that has a space which reduces the rigidity of a corresponding one of the main-body connecting portion and the cover connecting portion; and
a location of the fastening surface is displaced from an installation location of the main-body connecting portion in the axial direction of the predetermined central axis.

7. A valve device comprising:
a drive device that is configured to output a rotational force;
a valve element that has a flow passage which is configured to conduct a fluid through the flow passage, wherein the valve element is configured to adjust a flow rate of the fluid flowing in the flow passage when the valve element is rotated about a predetermined central axis by the rotational force outputted from the drive device;
a housing main body that has:
a main-body peripheral wall which surrounds the predetermined central axis and forms a receiving space, wherein the receiving space receives the valve element; and
an opening which is formed at the housing main body on one side in an axial direction of the predetermined central axis;
a main-body cover that has a cover peripheral wall which surrounds the predetermined central axis, wherein the main-body cover is fastened to the housing main body and thereby closes the receiving space; and
a seal member that is resiliently deformed between the housing main body and the main-body cover to seal a gap between the housing main body and the main-body cover, wherein:
the housing main body has:
a main-body connecting portion that radially outwardly extends from the main-body peripheral wall to a location which is on a radially outer side of the seal member in a radial direction of the predetermined central axis; and
a main-body fastening portion that is joined to a radially outer end part of the main-body connecting portion and has a fastening surface which contacts the main-body cover;
the main-body cover has:
a cover connecting portion that radially outwardly extends from the cover peripheral wall to a location which is on the radially outer side of the seal member in the radial direction of the predetermined central axis; and
a cover fastening portion that is joined to a radially outer end part of the cover connecting portion and has a contact surface which contacts the fastening surface;
at least one of the housing main body and the main-body cover has a corresponding one of:
a rigidity reducing structure that includes a main-body rigidity reducing part that reduces a rigidity of the main-body connecting portion in comparison to a case where the main-body rigidity reducing part is absent at the main-body connecting portion; and
a rigidity reducing structure that includes a cover rigidity reducing part that reduces a rigidity of the cover connecting portion in comparison to a case where the cover rigidity reducing part is absent at the cover connecting portion;
at least one of the rigidity reducing structures is a structure that has a space which reduces the rigidity of a corresponding one of the main-body connecting portion and the cover connecting portion;
the housing main body and the main-body cover are made of resin; and
at least one of the main-body rigidity reducing part and the cover rigidity reducing part is in a bottomed form and has an opening on one side and a closed bottom on an opposite side that is opposite to the one side.
